(19) United States
(12) Patent Application Publication
(10) Pub. No.: US 2009/0251667 A1
(43) Pub. Date: Oct. 8, 2009

(54) Projector and color adjusting method thereof

(75) Inventors: Hsin-Chi Chen, Hsinchu (TW); Chih-Heng Fan Chiang, Hsinchu (TW); Yen-Hsiang Hung, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/379,957

(22) Filed: Mar. 5, 2009

(30) Foreign Application Priority Data
Apr. 3, 2008 (TW) 097112373

(51) Int. Cl. G03B 21/00

(52) U.S. Cl. 352/42; 352/198

(57) ABSTRACT

A color adjusting method is applied to a projector. The projector has a light emitting element and a color wheel. The light emitting element supplies light, and makes the light pass through the color wheel so as to generate a plurality of different color lights. These different color lights are used to form a color image. The color adjusting method includes the steps of providing a plurality of driving waveforms which is dynamically switched for driving the light emitting element; defining a major color light of the color image, which is selected from the different color lights; and switching to one of these driving waveforms when the major color light is generated by the light passing through the color wheel. Thus, the light energy of the major color light is enhanced by means of driving the light emitting element through the switched driving waveform.

### BACKGROUND OF THE INVENTION

(1) Field of the Invention

The present invention relates to a projector and a color adjusting method thereof, and particularly to a color adjusting method applied to a digital light processing (DLP) projector.

(2) Description of the Prior Art

Digital Light Processing (DLP) is the projection technology developed by Taxes Instrument (TI), applying mirror reflection imaging principle and owning the advantages of full digital, high contrast and exquisite image. Meanwhile, the projector using this technology may effectively reduce its volume and weight to become light, thin, short and small.

Refer to FIG. 1 for a schematic view of the conventional DLP projector 100. The DLP projector 100 has at least a bulb 120, a color wheel 140, a Digital Micromirror Device (DMD) 160 and a scaler 180.

The light path of the DLP projector 100 is described as follows: the light generated by the bulb 120, and passing through different color zones 142,144 on the color wheel 140 so as to generate a plurality of different color lights; the color lights reaching the DMD 160 after several reflections or refractions; the DMD 160 controlled by the scaler 180, modulating the color lights to form an image light; projecting the image light to the screen (not shown) outside the DLP projector 100 through a lens (not shown) to form a color image.

The bulb 120 is used to generate all light paths of the DLP projector 100 and ensure the enough brightness of the color image on the screen. To adjust the brightness and the color performance of the color image, the bulb 120 commonly utilizes a ballast 124. In general, when the bulb 120 keeps bright, the ballast 124 may use a special waveform to enhance the performance of a special color.

Refer to FIG. 2 for the waveform W and the color zone list 140S of the bulb 120 in the DLP projector 100. In FIG. 2, the waveform W contains a pulse P. The color zones on the color zone list 140S represent different color zones on the color wheel 140. For instance, the color zone 146 stands for a transparency area in the color wheel 140. The waveform W supplies an strengthened pulse P to enhance the brightness of the white light when the color wheel 140 rotates to the transparency area.

However, for each color image, the conventional technology may only enhance the white light by the fixed waveform W, but unable to adjust the brightness and the color performance automatically according to the color distribution.

### SUMMARY OF THE INVENTION

The present invention is to provide a color adjusting method of a projector capable of adjusting the brightness or performance of the color light for different images automatically.

For one or part of or all objectives mentioned or other objectives, one embodiment of the present invention provides a color adjusting method applied to a projector with a light emitting element and a color wheel. The light emitting element supplies light. The light passes through the color wheel to generate a plurality of different color lights used to form a color image. The method includes the steps of: providing a plurality of driving waveforms dynamically switched for driving the light emitting element; defining a major color light of the color image, the major color light selected from one of the different color lights; and switching to one of the driving waveforms when the major color light is generated by the light passing through the color wheel, so as to enhance the light energy of the major color light by means of driving the light emitting element through the switched driving waveform.

The mentioned step of providing the driving waveforms includes: defining a major pulse and a plurality of sub-pulses within each of the driving waveforms, wherein the amplitude of the major pulse is larger than that of the sub-pulses. The major pulse and the sub-pulses in the same driving waveform each control the light energy of one of the different color lights. Noticeably, the major pulse of each of the driving waveforms controls the light energy of one of the different color lights.

In detail, the different color lights are respectively generated in a plurality of different time intervals continuously. In each driving waveform, the major pulse and the sub-pulses respectively act in the different time intervals continuously. In different driving waveforms, the major pulse and the sub-pulses have different orders.

Because the color image is formed by the different color lights, the color image includes a plurality of kinds of pixel units corresponding to the different color lights, each of the kinds of pixel units displaying the corresponding color light, and the step of defining the major color includes: comparing the number of pixels in each of the kinds of pixel units; and selecting one with the most number of pixels from the kinds of pixel units, whose the corresponding color light is defined as the major color light.

In above, the projector further includes a scaler to receive an image signal having a plurality of primary color signals such as red signal, blue signal and green signal. These primary color signals corresponds to the different color lights, respectively. Accordingly, the step of defining the major color light includes: detecting the energy intensity of each of the primary color signals; comparing the energy intensity of the primary color signals; and selecting one with the highest energy from the primary color signals, whose corresponding color light is defined as the major color light.

Another embodiment of the present invention provides a projector, which includes a light source, a color wheel, a light valve and a scaler. The light source includes a light emitting element and a lamp driver. The lamp driver is capable of providing a plurality of driving waveforms for switching therebetween to drive the light emitting element to generate light. The color wheel is disposed on a light path of the light for separating a plurality of different color lights from the light. The light valve is disposed on a light path of the different color lights for transferring the different color lights into a color image. The scaler is electrically connected to the light valve, and provides a selection mechanism for selecting from the driving waveforms.

The color wheel has a plurality of color segments rotatable in a period orderly to make the light pass through the color segments in order. The period equals the summation of the time intervals. The color image displays in a frame time, and the frame time is an integral multiple of the summation of the time intervals.

Because the color image is formed by the different color lights, the color image includes a plurality of kinds of pixel units corresponding to the different color lights respectively, each of the kinds of pixel units displaying the corresponding color light. The selection mechanism provided by the scaler includes: comparing the number of pixels in each of the kinds of pixel units; and selecting one with the most number of pixels from the kinds of pixel units, whose the corresponding color light is defined as the major color light.

The image signal received by the scaler has a plurality of primary color signals corresponding to different color lights respectively, and the selection mechanism includes: detecting the energy intensity of each of the primary color signals; comparing the energy intensity of the primary color signals; and selecting one with the highest energy from the primary color signals, whose the corresponding color light is defined as the major color light.

In conclusion, the color adjusting method and the projector using the method according to the embodiments of the present invention are able to adjust the color performance of the projecting image dynamically.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a conventional projector.

FIG. 2 is a schematic view of the waveform of the bulb in a conventional projector.

FIG. 3 is a block diagram showing an embodiment of a projector according to the present invention.

FIG. 4A is a flow chart of an embodiment selecting the waveform of the light emitting element in the projector according to the present invention.

FIG. 4B is a flow chart of an embodiment selecting the waveform of the light emitting element in the projector according to the present invention.

FIG. 5 is a schematic view of an embodiment showing the waveform of the light emitting element in a projector according to the present invention.

FIG. 6 is a flow chart of an embodiment showing the color adjusting method in the projector according to the present invention.

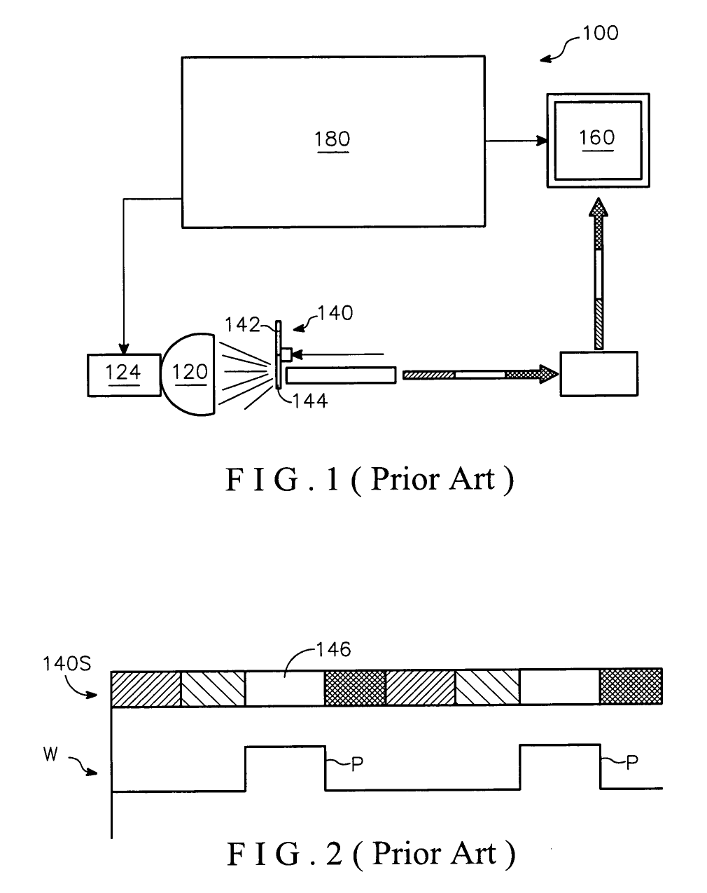

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

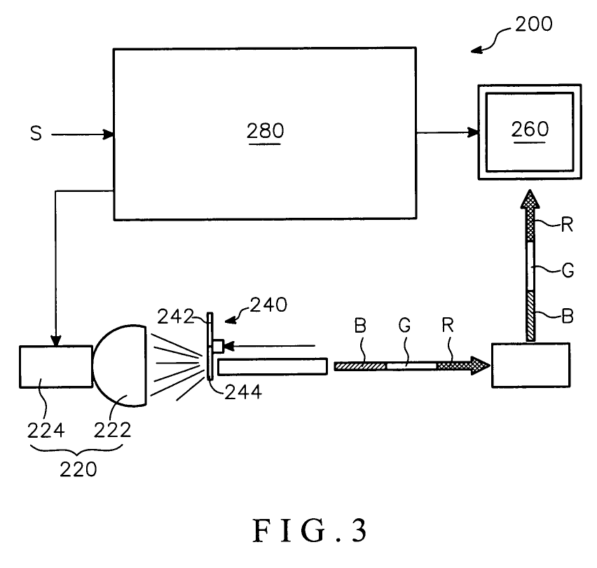

Referring to FIG. 3, a projector 200 has a light source 220 and a color wheel 240, a light valve 260 and a scaler 280. The light source 220 has a light emitting element 222 and a lamp driver 224. The light emitting element 222 provides light. The color wheel 240 is disposed on the light path for separating a plurality of different color lights R,G,B from the light. Noticeably, the lamp driver 224 provides a plurality of driving waveforms for switching therebetween, and one of the driving waveforms drives the light emitting element 222. The driving waveform is used to enhance the light energy of the R,G,B as well as the color performance of the R,G,B.

As shown in FIG. 3, the color wheel 240 has a plurality of color segments 242,244. With the rotation of the color wheel 240, the color segments 242 and 244 move to the light path orderly in a period T. For instance, FIG. 3 shows the color segment 244 is just rotated to the light path to let the light go. Thus, the light from the light emitting element 222 goes through the color segments 242,244 in order and generates a plurality of color lights accordingly and continuously. The light valve 260 is disposed on the light path of the color lights R,G,B to reflect the color lights R,G,B to form an image. In the embodiment, the image is a color image.

The scaler 280 which is connected to the light valve 260 electrically is utilized to receive an image signal S. Generally, after modulating the image signal S, the scaler 280 transfers it to the light valve 260 to control the angle of the micro lens of the light valve 260. The scaler 280 which is also electrically connected to the lamp driver 224 offers a selection mechanism for selecting dynamically from the driving waveforms supplied by the lamp driver 224.

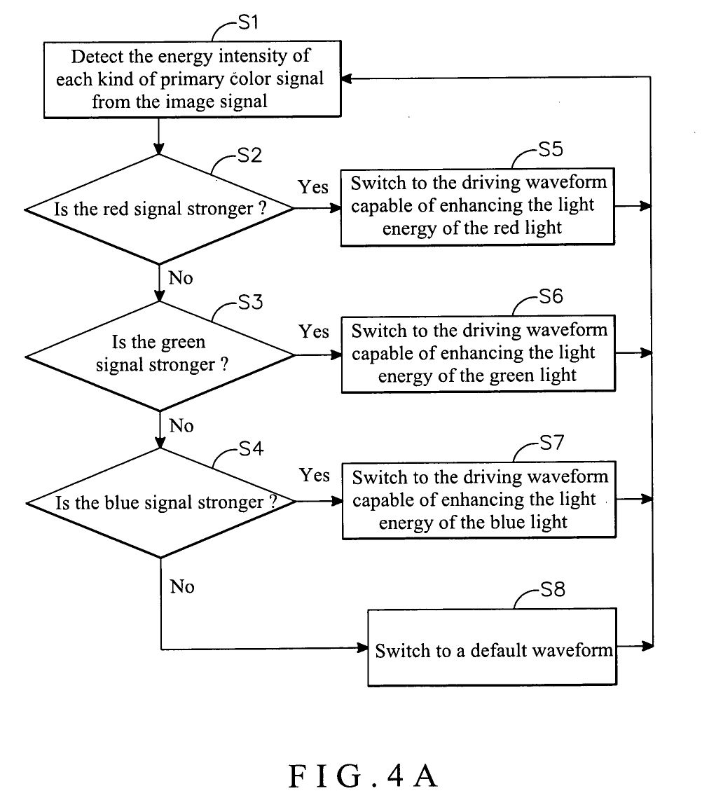

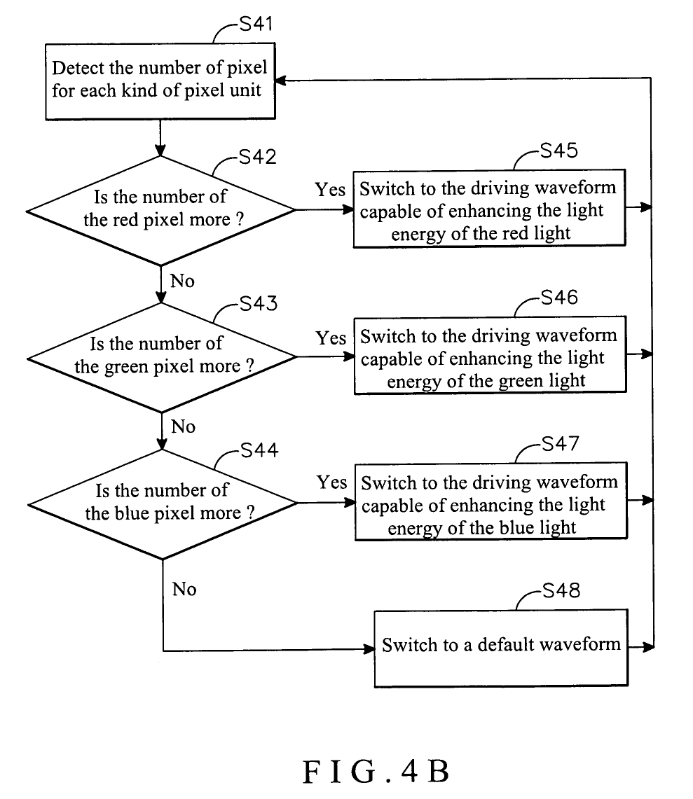

Referring to FIG. 4A, in the embodiment, the image signal S has a plurality of kinds of primary color signals, such as a red signal, a blue signal and a green signal. The scaler 280 detects the kinds of primary color signals from the image signal S and performs the selection mechanism to select a major color light for the color image, and does further selection from the driving waveforms supplied by the lamp driver 224 according to the major color light.

As FIG. 4A shows, the selection mechanism includes the following steps: the scaler 280 detecting the energy intensity of each kind of primary color signals (S1) and selecting one with the strongest energy by comparing their energy intensity (S2˜S4), then regarding the color light corresponding to the primary color signal with the strongest energy as the major color light to form the color image. For example, if the energy intensity of the red signal is strongest, the red light is the major color light of the color image (S2). Finally, according to the major color light, switch to the driving waveform which is capable of enhancing the light energy of the red light (S5).

Similarly, if the energy intensity of the green signal is stronger (S3), switch to the driving waveform (S6) which is capable of enhancing the light energy of the green light. If the energy intensity of the blue signal is stronger (S3), switch to the driving waveform (S7) which is capable of enhancing the light energy of the blue light. In addition, the lamp driver 224 may also supply a default driving waveform. If not detect the stronger primary color signal, switch to the default driving waveform (S8).

Referring to FIG. 4B, in another embodiment, the scaler 280 provides another selection mechanism as follows. The color image generally includes a plurality of color lights R,G,B, which also means the color image has a plurality of kinds of pixel units corresponding to the color lights respectively, each kind of pixel units displays the corresponding color light thereof. Thus, when selecting the major color light, the scaler 280 first detects the number of pixels for each of the kinds of pixel units (S41) in the color image, and then compares the numbers of pixels in each of the kinds of pixel units (S42˜S44) to select one with the most number of pixels to define its color light as the major color light of the color image. According to the major color light, switch to the driving waveform capable of enhancing the energy of the major color light (S45˜S47). If not detect the pixel unit having the most number of pixels, switch to the default driving waveform (S48).

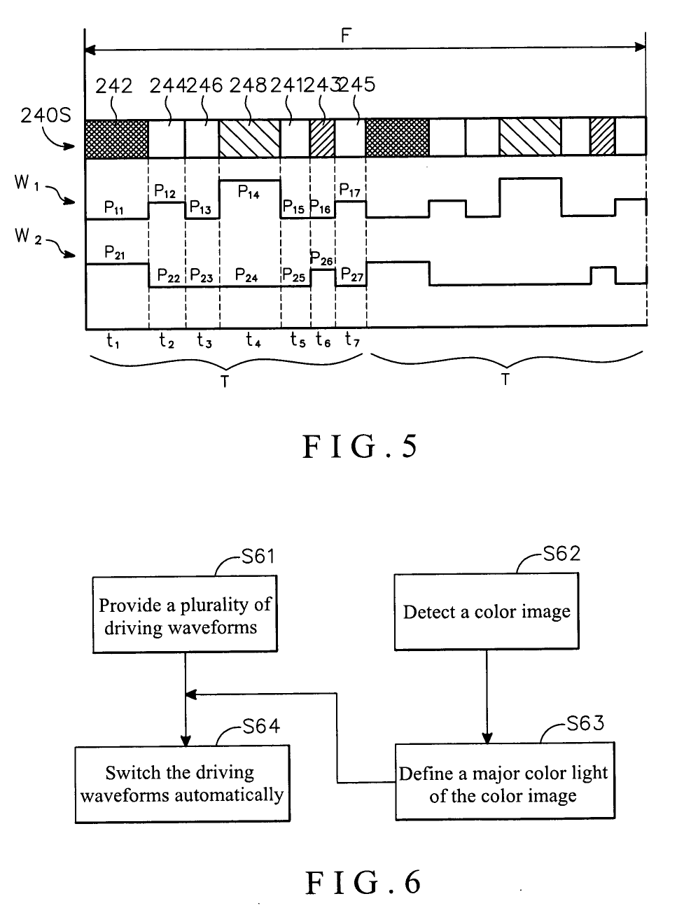

Refer to FIG. 5 for two driving waveforms W₁,W₂. The driving waveforms W₁ and W₂ built in the lamp driver 224 are designed according to the color segment defined by the color wheel 240. In the embodiment, the color segment defined by the color wheel 240 is in the order: red segment 242, green segment 244, blue segment 246, white segment 248, light blue segment 241, pink segment 243 and yellow segment 245, called color segment sequence 240S.

Each of the driving waveforms W₁,W₂ has a plurality of pulses. In FIG. 5, the pulses P₁₁, P₁₂, P₁₃, P₁₄, P₁₅, P₁₆, P₁₇ of the driving waveform W₁ act separately on the color segments 242, 244, 246, 248, 241, 243, 245 of the color wheel 240 in time intervals t₁, t₂, t₃, t₄, t₅, t₆,t₇ to control the light energy of different color lights. Similarly, the pulses P₂₁, P₂₂, P₂₃, P₂₄, P₂₅, P₂₆, P₂₇ of the driving waveform W₂ act separately on the color segments 242, 244, 246, 248, 241, 243,245 of the color wheel 240 in t₁, t₂, t₃, t₄, t₅, t₆,t₇. In the embodiment, the period T of the color segments 242, 244, 246, 248, 241, 243, 245 is equal to the summation of time intervals t₁, t₂, t₃, t₄, t₅, t₆,t₇.

To make the driving waveforms W₁,W₂ enhance the light energy of the different color lights, the driving waveforms W₁,W₂ is designed by following steps: defining a major pulse P₁₄ and a plurality of sub-pulses P₁₁, P₁₂, P₁₃, P₁₅, P₁₆, P₁₇ from the pulses P₁₁, P₁₂, P₁₃, P₁₄, P₁₅, P₁₆, P₁₇ of the driving waveform W₁; making the amplitude of the major pulse P₁₄ larger than that of the sub-pulses P₁₁, P₁₂, P₁₃, P₁₅, P₁₆, P₁₇; similarly, defining a major pulse P₂₁ and a plurality of sub-pulses P₂₂, P₂₃, P₂₄, P₂₅, P₂₆, P₂₇ from the pulses P₂₁, P₂₂, P₂₃, P₂₄, P₂₅, P₂₆, P₂₇ of the driving waveform W₂; making the amplitude of the major pulse P₂₁ larger than that of the sub-pulses P₂₂, P₂₃, P₂₄, P₂₅, P₂₆, P₂₇. Noticeably, the major pulses P₁₄,P₂₁ of the driving waveforms W₁,W₂ control the energy of different color lights. When the driving waveform W₁ or W₂ drives the light emitting element 222, the energy of one color light is strengthened, and the energy of other color lights may be weakened. Thus, the performance of the color is strengthened by enhancing the brightness of the color light.

Referring to FIG. 5, the major pulse P₁₄ of the driving waveform W₁ is used to enhance the energy of the white light and the major pulse P₂₁ of the driving waveform W₂ is used to enhance the energy of the red light. For example, to project a briefing with a white background, the scaler 280 dynamically switches to the driving waveform W₁ when detecting the white background. Hence, users may feel the white light brighter because of enhancing the light energy of the white segment 248.

For example, if projecting a film with a lot of explosive scenes, red is an important color, so the scaler 280 dynamically switches to the driving waveform W₂ when detecting the explosion. Hence, the user may feel the red light brighter because of enhancing the light energy of the red segment 242.

In the embodiment, the time of displaying a complete color image is called a frame time F. The color segment sequence 240S in FIG. 5 repeats twice in the fame time F. Thus, the frame time F is an integral multiple of the summation of the time interval t₁, t₂, t₃, t₄, t₅, t₆,t₇ (or the period T).

Referring FIG. 6, the color adjusting method of the projector 200 in the embodiment includes the steps of: providing a plurality of driving waveforms W1, W2 capable of being dynamically switched for driving the light emitting element 222 (S61); detecting the color image (S62) for defining the major color light (S63) of the color image, which is selected from the color lights R, G, B generated by the color wheel 240; and switching to one of these driving waveforms W1, W2 when the major color light is generated by the light passing through the color wheel 240. Thus, the light energy of the major color light is enhanced (S64) by driving the light emitting element 222 through the switched driving waveform W1 or W2.

Each of the major pulse and the sub-pulses in the same driving waveform respectively acts in a plurality of different time intervals continuously. In different driving waveforms, the major pulse and the sub-pulses have different orders.

When the projector 200 displays a certain color image in the frame time F, the scaler 280 dynamically detects the color with the strongest performance and switches automatically to the corresponding driving waveform to strengthen the color performance effect. When the color wheel 240 displays the color segment of this color, in the time interval of this color, the lamp driver 224 drives the light emitting element 222 by the enlarged pulse to enhance the performance of this color.

In conclusion, the color adjusting method in the embodiments according to the present invention and the projector 200 applying this method may adjust the color in the color image dynamically or strengthen the performance of one or more colors.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A color adjusting method, applied to a projector with a light emitting element and a color wheel, the light emitting element supplying light, and the light passing through the color wheel to generate a plurality of different color lights used to form an image, the method comprising the steps of:
providing a plurality of driving waveforms dynamically switched for driving the light emitting element;
defining a major color light of the image, the major color light selected from one of the different color lights; and
switching to one of the driving waveforms when the major color light is generated by the light passing through the color wheel, so as to enhance the light energy of the major color light by means of driving the light emitting element through the switched driving waveform.

2. The color adjusting method of claim 1, wherein the step of providing the driving waveforms comprises:
defining a major pulse and a plurality of sub-pulses within each of the driving waveforms, wherein the amplitude of the major pulse is larger than that of the sub-pulses, and the major pulse and the sub-pulses in the same driving waveform each control the light energy of one of the different color lights.

3. The color adjusting method of claim 2, wherein the major pulse of each of the driving waveforms controls the light energy of one of the different color lights.

4. The color adjusting method of claim 1, wherein the different color lights are respectively generated in a plurality of different time intervals continuously, and the steps of providing the driving waveforms comprises:
defining a major pulse and a plurality of sub-pulses within each of the driving waveforms, the major pulse and the sub-pulses respectively acting in the different time intervals continuously; and
the major pulse and the sub-pulses within each of the driving waveforms having different orders corresponding to the different time intervals.

5. The color adjusting method of claim 1, wherein the image comprises a plurality of kinds of pixel units corresponding to the different color lights, each of the kinds of pixel units displaying the corresponding color light, and the step of defining the major color light comprises:
comparing the number of pixels in each of the kinds of pixel units; and
selecting one with the most number of pixels from the kinds of pixel units, whose the corresponding color light is defined as the major color light.

6. The color adjusting method of claim 1, wherein the projector further comprises a scaler to receive an image signal having a plurality of primary color signals corresponding to the different color lights respectively, and the step of defining the major color light comprises:
detecting the energy intensity of each of the primary color signals;
comparing the energy intensity of the primary color signals; and
selecting one with the highest energy from the primary color signals, whose the corresponding color light is defined as the major color light.

7. The color adjusting method of claim 6, wherein the primary color signals comprises a red signal, a blue signal and a green signal.

8. A projector, comprising:
a light source, comprising a light emitting element and a lamp driver, wherein the lamp driver is capable of providing a plurality of driving waveforms for switching therebetween to drive the light emitting element to generate light;
a color wheel, disposed on a light path of the light for separating a plurality of different color lights from the light;
a light valve, disposed on a light path of the different color lights, for transferring the different color lights into an image; and
a scaler, electrically connected to the light valve and providing a selection mechanism for selecting from the driving waveforms according to the selection mechanism.

9. The projector of claim 8, wherein each of the driving waveforms comprises a major pulse and a plurality of sub-pulses, the amplitude of the major pulse larger than that of the sub-pulses, the major pulse and the sub-pulses in the same driving waveform each controlling the light energy of one of the different color lights.

10. The projector of claim 9, wherein the major pulse of each of the driving waveforms controls the light energy of one of the different color lights.

11. The projector of claim 10, wherein the major pulse and the sub-pulses respectively act in a plurality of different time intervals continuously.

12. The projector of claim 11, wherein the color wheel has a plurality of color segments rotatable in a period orderly to make the light pass through the color segments in order, the period equaling the summation of the time intervals.

13. The projector of claim 12, wherein the image displays in a frame time, and the frame time is an integral multiple of the summation of the time intervals.

14. The projector of claim 8, wherein the image has a plurality of kinds of pixel units corresponding to the different color lights, each of the kinds of pixel units displaying the corresponding color light, the selection mechanism of the scaler comprising:
comparing the number of pixels in each of the kinds of pixel units; and
selecting one with the most number of pixels from the kinds of pixel units, whose the corresponding color light is defined as the major color light.

15. The projector of claim 8, wherein the scaler is capable of receiving an image signal having a plurality of primary color signals corresponding to the different color lights respectively, and the selection mechanism comprises:
detecting the energy intensity of each of the primary color signals;
comparing the energy intensity of the primary color signals; and
selecting one with the highest energy from the primary color signals, whose the corresponding color light is defined as the major color light.

16. The projector of claim 15, wherein the primary color signals comprises a red signal, a blue signal and a green signal.
